(19) United States
(12) Patent Application Publication
(10) Pub. No.: US 2004/0225474 A1
(43) Pub. Date: Nov. 11, 2004

(54) Damage tolerance using adaptive model-based methods

(75) Inventors: Neil J. Goldfine, Newton, MA (US); Vladimir A. Zilberstein, Chestnut Hill, MA (US); David C. Grundy, Reading, MA (US); Andrew P. Washabaugh, Chula Vista, CA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Jentek Sensors, Inc., Waltham, MA

(21) Appl. No.: 10/763,573

(22) Filed: Jan. 22, 2004

Related U.S. Application Data
(60) Provisional application No. 60/442,338, filed on Jan. 23, 2003.
(60) Provisional application No. 60/487,346, filed on Jul. 14, 2003.

(51) Int. Cl. G06F 15/00

(52) U.S. Cl. 702/183

(57) ABSTRACT

A model based framework utilizing a vector of multiple material states integrates nondestructive evaluation methods that provide observability of precursor and damage states with health control actions to reduce sustainment costs and extend component lifetimes. This evaluation includes usage monitoring and onboard diagnostics to ensure damage state observability. With an adaptive damage tolerance model, a set of precursor and damage states are assumed. Monitoring of precursor states, early damage detection, and observable health control actions, combined with onboard diagnostics, permit reduced costs and ensure readiness.

### RELATED APPLICATIONS

This application claims the benefit of U.S. Provisional Application No. 60/442,338, filed Jan. 23, 2003, and 60/487,346, filed Jul. 14, 2003, the entire teachings of which are incorporated herein by reference.

### BACKGROUND OF THE INVENTION

The technical field of this invention is that of nondestructive materials evaluation and its incorporation into condition based maintenance (CBM) and prognostics and health monitoring (PHM) programs. Nondestructive evaluation (NDE) methods provide information about near-surface and bulk material condition for flat and curved parts or components. These methods can include periodic inspections as well as usage monitoring with onboard diagnostics. This information is then used in decision protocols for CBM and PHM programs that are used to extend the service life of a variety of systems, such as engines and aircraft.

NDE of legacy and new aircraft platforms, performed at the depot or in the field, and onboard diagnostics (and more recently prognostics) have some common objectives. With the goal of reduced sustainment costs, new developments in NDE have been focused on early stage damage detection. This includes onboard NDE for monitoring of damage progression and detection of cracks. Similarly, onboard diagnostics methods, such as vibration monitoring, may reduce depot and field inspection burdens. For critical components such as engine disks, onboard diagnostic sensors can detect damage and may prevent in-service catastrophic failures. In the end, safety must be ensured on either a statistical or deterministic level. At the same time, the goal is to reduce sustainment costs while maintaining a high level of operational readiness.

A significant impediment to NDE inspections in the field (as opposed to depot) and to onboard diagnostics and prognostics is the potential for excessive false indications that directly impact readiness. Response actions are more limited in the field than in the depot and are far more limited onboard. For example, the majority of indications from depot level NDE might be eliminated as inconsequential or repaired. Such rework/repair options are limited in the field and are essentially nonexistent during operation. Also, different failure behaviors introduce different requirements for observability of damage progression and for the allowable reaction time to detected faults. For example, Foreign Object Damage (FOD) cannot be anticipated, thus, available onboard sensors must be used. On the other hand, fatigue damage in the absence of FOD may progress gradually and can, in many cases, be monitored at early stages with appropriate sensors.

Existing Damage Tolerance (DT) methods use predictive tools for crack growth to set NDE inspection intervals, successfully reducing premature component retirements. These damage tolerance methodologies assume an initial crack size, just below the detection threshold of available NDE methods. For example, in a military aircraft structure (e.g., lapjoint) a crack growth model is used to predict the progression of the assumed initial crack. The critical crack size is that size at which the component's residual strength reaches the level at which the component is no longer damage tolerant. Inspection intervals are then set at a fraction of the time it takes for the assumed initial crack to reach this critical crack size.

DT often includes scheduled depot level inspections such as those performed by the Retirement for Cause facilities for engine disk slot inspection. For many applications, when the life extension benefit of retirement for cause is accounted for, traditional NDE is sufficient and relatively low in cost. For these applications, NDE provides a mechanism for detecting damage, e.g., a crack, before it reaches a critical crack size. For other critical components, damage progresses slowly for most of the component's life at levels below the detection thresholds of traditional NDE and on-board diagnostics. Thus, for those components, extremely conservative and costly maintenance or retirement-for-time practices are used to avoid in-service failures.

For some components, design for safe operation over the lifetime is necessary because access for inspection is not possible. As a result, these components must be “overdesigned” to ensure safe life operation well beyond the anticipated service life. For new platforms, such requirements may impact weight and introduce other operational constraints, in addition to higher costs. For legacy platforms, extending life beyond original design objectives often introduces ominous inspection requirements for locations never intended to be accessible for inspections. One alternative for these components is the use of onboard diagnostics to detect impending failures over expansive structures, and advanced sensors that can meet NDE requirements in previously uninspectable or difficult-to-access locations.

One type of advanced NDE sensor suitable for inspection or monitoring of difficult-to-access locations are flexible and conformable eddy current sensors. Examples of such conformable sensors are described, for example, by Goldfine (U.S. Pat. No. 5,453,689), Vernon (U.S. Pat. No. 5,278,498), Hedengren (U.S. Pat. No. 5,315,234) and Johnson (U.S. Pat. No. 5,047,719). These sensors permit characterization of bulk and surface material conditions. Characterization of bulk material condition includes (1) measurement of changes in material state, i.e., degradation/damage caused by fatigue damage, creep damage, thermal exposure, or plastic deformation; (2) assessment of residual stresses and applied loads; and (3) assessment of processing-related conditions, for example from aggressive grinding, shot peening, roll burnishing, thermal-spray coating, welding or heat treatment. It also includes measurements characterizing material, such as alloy type, and material states, such as porosity and temperature. Characterization of surface and near-surface conditions includes measurements of surface roughness, displacement or changes in relative position, coating thickness, temperature and coating condition. Each of these includes detection of electromagnetic property changes associated with either microstructural and/or compositional changes, or electronic structure (e.g., Fermi surface) or magnetic structure (e.g., domain orientation) changes, or with single or multiple cracks, cracks or stress variations in magnitude, orientation or distribution.

Conventional eddy-current sensing involves the excitation of a conducting winding, the primary, with an electric current source of prescribed frequency. This produces a time-varying magnetic field at the same frequency, which in turn is detected with a sensing winding, the secondary. The spatial distribution of the magnetic field and the field measured by the secondary is influenced by the proximity and physical properties (electrical conductivity and magnetic permeability) of nearby materials. When the sensor is intentionally placed in close proximity to a test material, the physical properties of the material can be deduced from measurements of the impedance between the primary and secondary windings. Traditionally, scanning of eddy-current sensors across the material surface is then used to detect flaws, such as cracks. Conventional eddy-current sensors widely used in nondestructive testing applications are effective at examining near surface properties of materials, but have a limited capability to examine material property variations deep within a material. In contrast, ultrasonic techniques that are also widely used are effective at measuring property variations deep within a material, but have limited sensitivity near the surface and behind some geometric features such as air gaps.

### SUMMARY OF THE INVENTION

Aspects of the invention described herein involve novel sensors and sensor arrays for measurement of the near surface properties of conducting and/or magnetic materials. These sensors and arrays use novel geometries for the primary winding and sensing elements that promote accurate modeling of the response and provide enhanced observability of property changes of the test material.

In one embodiment of the invention, there are methods for monitoring of material properties as they are changed during service and scheduling of inspections to ensure the integrity of the material. This can involve representing the condition of the material with multiple states, at least one of the states observable with a sensor, and estimating the progression of these states with a model. In one embodiment of the invention, the states include damage of the material. In another, the states include precursors to damage. In yet another embodiment of the invention, the model is used to pre-compute a database of damage conditions and their progression to facilitate rapid or real-time assessment of the damage conditions to support decisions regarding the disposition of the material. The model can also be adapted as the states progress through different levels, such as the relief of residual stresses to subsequently crack propagation. In one embodiment of the invention, the states are selected to ensure that inspections will be able to observe the progression of the damage condition. In a preferred embodiment of the invention, one of the states is an initially preassumed crack size, as in damage tolerance methods. In yet another embodiment of the invention, one of the states for the material condition is the level of fatigue. The fatigue can be monitored either continuously or occasionally. Preferably, when the damage is monitored occasionally, the frequency of the inspections increases as the damage progressions.

In a preferred embodiment of the invention, the inspection is performed with a nondestructive testing method so that the integrity of the material is not compromised by the inspection method. In one embodiment of the invention, the inspection includes the use of eddy current sensors or sensor arrays mounted onto a surface of the test material. In another embodiment of the invention, the inspection can use on-board diagnostic approaches to ensure that the sensors used for the inspection are functioning correctly. This is particularly important for surface mounted sensors that may be in areas of limited access. In one embodiment of the invention, the rates of change of selected states, such as the first derivative or even second or higher order derivatives, are monitored, which can contribute to the state progression estimation. These rates of change or derivatives can be estimated from two or more inspections at different times.

In one embodiment of the invention, the material is part of an aircraft component. Furthermore, the disposition of the component, regarding for example airworthiness, maintenance of the aircraft, or reconditioning such as repair or rework, is made depending states of the material condition. Similarly, as part of the material condition monitoring, health control actions may be performed to achieve a quantitative goal, such as the reduction of total ownership costs without reducing readiness. In one embodiment of the invention, the quantitative goal is constructed from an assessment of available quantitative and historical information along with expert qualitative information. The control action can include rework of a component, such as the cold work process of shot peening.

In another embodiment of the invention, health control of a material is performed by a method in which an article is inspected with an eddy current sensor to determine the presence of precursor or early stage damage, operated upon with a health control action to recondition the article and then reinspected to establish a baseline condition for scheduling of future inspections. The sensor may be an eddy current sensor array. In other embodiments of the invention, the sensor may be either mounted on or scanned over a surface of the article. The control action can include reworking, such as the cold work process of shot peening. Furthermore, the health control action can be integrated into a framework for the life-time monitoring of the material such that the baseline response provides a basis for scheduling of future inspections.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 illustrates an example damage tolerance flow diagram for fatigue cracks;

FIG. 2 illustrates an example adaptive damage tolerance flow diagram for fatigue damage;

FIG. 3 is a drawing of a spatially periodic field eddy-current sensor;

FIG. 4 is an expanded view of the drive and sense elements for an eddy-current array having offset rows of sensing elements;

FIG. 5 is an expanded view of the drive and sense elements for an eddy-current array having a single row of sensing elements;

FIG. 6 is an expanded view of an eddy-current array where the locations of the sensing elements along the array are staggered;

FIG. 7 is an expanded view of an eddy current array with a single rectangular loop drive winding and a linear row of sense elements on the outside of the extended portion of the loop;

FIG. 8 illustrates the effective conductivity changes as a function of percent of fatigue life for Type 304 stainless steel;

FIG. 9 illustrates the progression of fatigue damage revealed by a permanently mounted MWM-Array for a low alloy steel;

FIG. 10 shows the MWM measured magnetic permeability versus bending stress in a shot peened high-strength steel specimen at stresses from −700 to 700 MPa;

FIG. 11 illustrates a schematic progression of damage for a component where damage progresses gradually from detectable damage initiation (1) and accelerates to critical over a period of time. X represents failure of the component;

FIG. 12 illustrates a schematic progression of damage for a component with the effect of “upset” events at different stages of life. X represents failure of the component;

FIG. 13 illustrates a representative measurement grid relating the magnitude and phase of the sensor terminal impedance to the lift-off and magnetic permeability;

FIG. 14 illustrates a representative measurement grid relating the magnitude and phase of the sensor terminal impedance to the lift-off and electrical conductivity.

### DETAILED DESCRIPTION OF THE INVENTION

A description of preferred embodiments of the invention follows.

The disclosed invention addresses the limitations of damage tolerance methods and can be described as an Adaptive Damage Tolerance (ADT) method. In the simplest sense, ADT is a DT methodology that adds a model-based adaptation of inspection intervals based on available precursor and damage states. This incorporation of multiple state information, for example, precrack or stress level in addition to crack size, into a model for the system response so that inspection intervals and usage can be modified as necessary. While the following focus on aircraft, the approach is suitable for management of any critical component for which sufficient observability is available for the relevant precursor and damage states. The “health control” objective is to reduce total ownership costs and increase operational readiness, while maintaining safety.

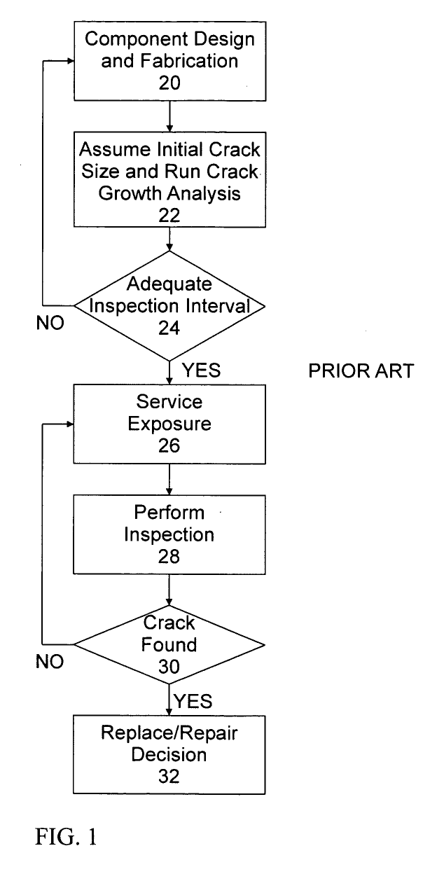

FIG. 1 provides a flow diagram of a typical DT methodology applied to fatigue cracks. Initially, a (typically) iterative design process is involved wherein after a component is designed and fabricated 20, crack growth models using assumed initial crack sizes 22 are used to determine inspection intervals 24. If the inspection interval is too short, the component is redesigned. Otherwise, the component is placed into service 26 and periodically inspected 28 to determine if cracks are present 30. If no cracks are found, the component is returned to service. Otherwise, the component is either replaced or repaired 32.

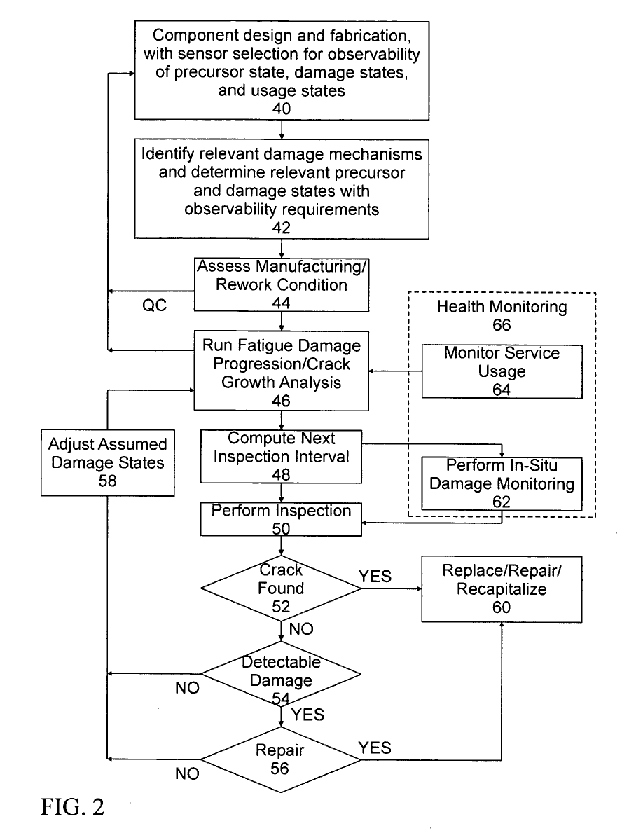

FIG. 2 provides a similar flow diagram for a possible ADT method applied to fatigue damage. In this case, as part of the initial component design and fabrication process 40, sensors are selected for the observability of precursor, usage, and damage states. Next, the critical damage mechanisms are identified 42 and the relevant precursor and damage states are determined in conjunction with the observability requirements. The condition of the component 44 is then assessed as part of a quality control (QC) procedure. If the condition is satisfactory, then the condition states are input to a fatigue damage and crack growth analysis model 46. If the condition of the component or the fatigue analysis is not satisfactory, then alternative sensors are selected or the component is redesigned or refabricated. The next inspection interval is calculated 48 and the component is placed into service. As part of the health monitoring program 66, the service usage is monitored 64 and input to the fatigue analysis model 46 to better estimate the progression of fatigue damage. This health monitoring may also include the in-situ monitoring of damage 62, which can be accomplished for example with surface mounted eddy current sensors. The intervals for these in-situ inspections 48 can be determined from the fatigue model and the monitoring results can be consolidated with other inspection results 50. If a crack is not found 52, the inspection results are analyzed to determine if any other damage is detectable 54. If there is no damage or the component cannot be repaired 56, the damage states for the component 58 are updated and fed back into the fatigue model 46. If the component has cracks or reparable damage, the component is then analyzed to determine the appropriate disposition, such as repair, replacement, or recapitalization 60. The condition of rework parts is then assessed to determine fitness for service 44. A performance goal of this ADT method is the recapitalization of a substantial portion of the component life.

This formulation for ADT introduces several new concepts. One is a requirement to provide observability of precursor states. Precursor states are defined here as states that affect the early behavior of a specific damage mode while observability is a control theory term, represented for linear multivariate systems by the observability matrix. Examples of precursor states are inadequate residual stresses, either as manufactured or as modified in service, undesirable surface conditions (e.g., from manufacturing or fretting), geometric features, microstructure variations (e.g., from aggressive machining in titanium engine disks, or from grind burns in low alloy steel components). In this context, observability implies not only the capability to measure specific damage states and their rates of change, but also to measure them independently and reliably.

A second concept is the adjustment of unobservable damage state assumptions to produce model derived failure statistics representative of observed failures in the fleet or component tests. These unobservable damage states are states that cannot yet be monitored nondestructively, but can be included in prognostics models of failure mode progression. Note, however, that the sequential nature of damage behavior may permit the bounding of unobservable conditions through observations that the next stage of behavior has not yet started, e.g., no failures in the fleet might imply that cold working was accomplished correctly for a component population or population subset and that the unobservable damage states are still benign. In the current DT methods, the assumption about the initial unobserved crack size is not adjusted.

A third concept is the formation of a framework for combining data from field and depot NDE inspections with data from onboard sensors for monitoring of both usage and damage state progression. A fourth concept is the adjustment of traditional inspection intervals and onboard sensor data analysis intervals based on progression of damage states and usage. For example, data from on-board sensors might only be downloaded and analyzed at specified, adjustable intervals by selected authorities, as opposed to on-site analysis which could limit the effects of false positive indications that negatively impact readiness.

A fifth concept is the capability for detecting and accounting for possible upset events. These upset events are defined as a discrete event that shifts relevant damage states either in a positive or negative direction. An example would be a hard landing of an aircraft that unintentionally loads the landing gear relieves some of the shotpeening or prestressing introduced during manufacture.

A sixth concept is the adaptive recapitalization of components through maintenance/rework/repair and replacement actions as a method of introducing health control. Recapitalization is defined as a means of resetting or at least recovering a substantial portion of the component life through health control actions, such as grinding/blending areas affected by cracks or pits and reshotpeening, or stripping and recoating, expanding a fastener hole, or adding a doubler. Adaptive recapitalization includes adaptation of recapitalization methods based on models of damage progression for specific failure modes of concern, and within mission constraints. These control actions are a step beyond basic health management and imply the capability to alter the precursor and damage states using a measured action with a predictable response.

A seventh concept is the formulation of a quantitative performance goal incorporating total ownership cost and performance, with feedback from individual component and fleet-wide tracking. This performance goal might provide the objective for the asset health control. Fleetwide component quality assessment has been described in [Goldfine, October 2002].

The principal distinction between precursor states and damage states is that precursor states result from manufacturing processes and rework/repair events. Characterization of these states may introduce requirements for quality assessment beyond typical practices. Some precursor states, e.g. inadequate residual stress, may be further modified by subsequent in-service damage. For example, a shot peened or otherwise cold worked structural component might have been cold worked to extend high cycle fatigue life, but in practice substantial low cycle fatigue contribution may result in stress relaxation, making the component more susceptible to fatigue crack initiation and propagation.

In some applications, gradual or sudden changes of such precursor states may provide the only sufficiently early warning of subsequent failure, when, for example, time between crack initiation and failure is too short. This might be the case in a landing gear where a previous overload event, e.g., hard landing, changed the precursor states, e.g., residual stresses, without producing a detectable crack. For this example, the next overload event may result in a failure of the component. In this case, the focus should be on materials characterization to observe changes in the precursor states, and, when possible, on in-situ monitoring of critical locations using permanently mounted sensors.

One example of a currently used method for monitoring precursor states is the use of the Barkhausen noise method on landing gear. This method is used to remove landing gear components from service if they exhibit unacceptable residual stresses. Unfortunately, this method requires costly stripping of paint and produces a substantial number of false positive indications. An alternative is to use sensors such as Meandering Winding Magnetometer (MWM®) and MWM-Arrays that do not require paint removal and provide substantial improvements in reliability with reduced false indications. For example, the high-resolution imaging capability of the MWM-Array combined with the capability to perform bidirectional measurements can differentiate between residual stresses and microstructural conditions, for example, grinding burns. Such techniques are becoming more and more prevalent, not only for manufacturing quality control, but also as a means for detecting changes in precursor states to assess fitness for service.

The MWM is a “planar,” conformable eddy-current sensor that was designed to support quantitative and autonomous data interpretation methods. These methods, called grid measurement methods, permit crack detection on curved surfaces without the use of crack standards, and provide quantitative images of absolute electrical properties (conductivity and permeability) and coating thickness without requiring field reference standards (i.e., calibration is performed in “air,” away from conducting surfaces). MWM sensors and MWM-Arrays can be used for a number of applications, including fatigue monitoring and inspection of structural components for detection of flaws, degradation and microstructural variations as well as for characterization of coatings and process-induced surface layers. Characteristics of these sensors and sensor arrays include directional multi-frequency magnetic permeability or electrical conductivity measurements over a wide range of frequencies, e.g., from 250 Hz to 40 MHz with the same MWM sensor or MWM-Array, high-resolution imaging of measured permeability or conductivity, rapid permeability or conductivity measurements with or without a contact with the surface, and a measurement capability on complex surfaces with a hand-held probe or with an automated scanner. This allows the assessment of applied and residual stresses as well as permeability variations in a component introduced from processes such as grinding operations.

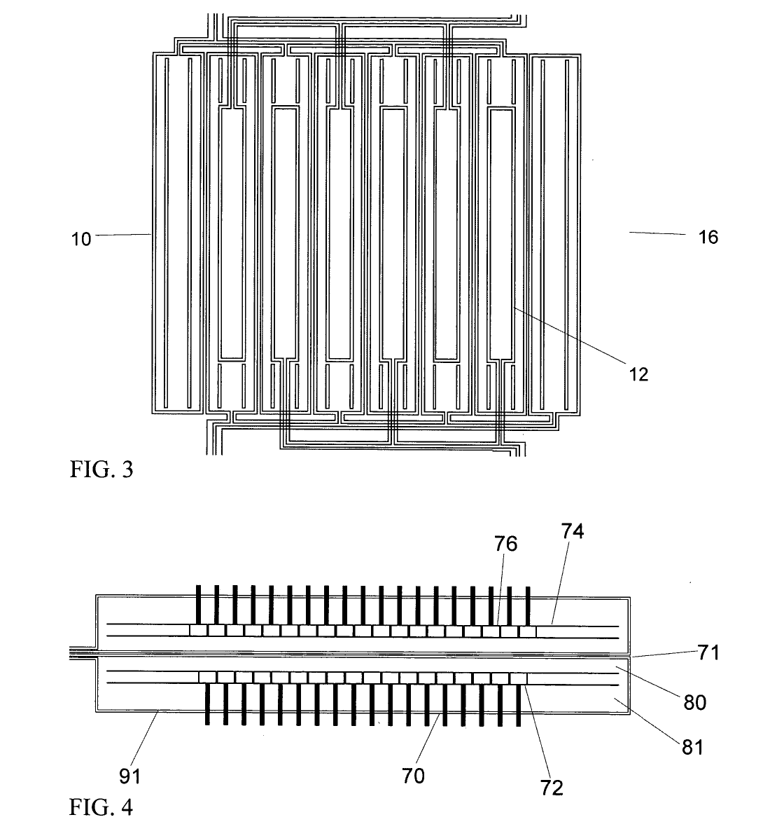

FIG. 3 illustrates the basic geometry of an the MWM sensor 16, a detailed description of which is given in U.S. Pat. Nos. 5,453,689, 5,793,206, and 6,188,218 and U.S. patent application Ser. Nos. 09/666,879 and 09/666,524, both filed on Sep. 20, 2000, the entire teachings of which are incorporated herein by reference. The sensor includes a primary winding 10 having extended portions for creating the magnetic field and secondary windings 12 within the primary winding for sensing the response. The primary winding is fabricated in a spatially periodic pattern with the dimension of the spatial periodicity termed the spatial wavelength λ. A current is applied to the primary winding to create a magnetic field and the response of the MUT to the magnetic field is determined through the voltage measured at the terminals of the secondary windings. This geometry creates a magnetic field distribution similar to that of a single meandering winding. A single element sensor has all of the sensing elements connected together. The magnetic vector potential produced by the current in the primary can be accurately modeled as a Fourier series summation of spatial sinusoids, with the dominant mode having the spatial wavelength λ. For an MWM-Array, the responses from individual or combinations of the secondary windings can be used to provide a plurality of sense signals for a single primary winding construct as described in U.S. Pat. No. 5,793,206 and Re. 36,986.

Eddy-current sensor arrays can be comprised of one or more drive windings, possibly a single rectangle, and multiple sensing elements. Example sensor arrays are shown in FIG. 4 through FIG. 6, some embodiments of which are described in detail in U.S. Patent Application numbers 10/102,620, filed Mar. 19, 2002, and Ser. No. 10/010,062, filed Mar. 13, 2001, the entire teachings of which are incorporated herein by reference. These arrays include a primary winding 70 having extended portions for creating the magnetic field and a plurality of secondary elements 76 within the primary winding for sensing the response to the MUT. The secondary elements are pulled back from the connecting portions of the primary winding to minimize end effect coupling of the magnetic field. Dummy elements 74 can be placed between the meanders of the primary to maintain the symmetry of the magnetic field, as described in U.S. Pat. No. 6,188,218. When the sensor is scanned across a part or when a crack propagates across the sensor, perpendicular to the extended portions of the primary winding, secondary elements 72 in a primary winding loop adjacent to the first array of sense elements 76 provide a complementary measurement of the part properties. These arrays of secondary elements 72 can be aligned with the first array of elements 76 so that images of the material properties will be duplicated by the second array (improving signal-to-noise through combining the responses or providing sensitivity on opposite sides of a feature such as a fastener as described in-U.S. patent application Ser. Nos. 10/102,620 and 10/010,062. Alternatively, to provide complete coverage when the sensor is scanned across a part the sensing elements, can be offset along the length of the primary loop or when a crack propagates across the sensor, perpendicular to the extended portions of the primary winding, as illustrated in FIG. 4.

The sensor and sensor array can be reconfigured with the geometry of the drive and sense elements and the placement of the sensing elements adjusted to improve sensitivity for a specific inspection. For example, the MWM is most sensitive to cracks when the cracks are oriented perpendicular to the drive windings and located under or near the drive windings. Thus the winding pattern can be designed or selected to accommodate anticipated crack distributions and orientations. In cases where cracks oriented in all directions must be detected, stacked MWM-Arrays with orthogonal drive windings can be used. As another example, the effective spatial wavelength or four times the distance 80 between the central conductors 71 and the sensing elements 72 can be altered to adjust the sensitivity of a measurement for a particular inspection. Increasing the effective spatial wavelength tends to increase the depth of sensitivity. Similarly, increasing the distance between the longer segments of the drive winding typically increases the depth of sensitivity for deeper/buried cracks, but reduces the sensitivity to near surface cracks. effective spatial wavelength For the sensor array of FIG. 4, the distance 80 between the secondary elements 72 and the central conductors 71 is smaller than the distance 81 between the sensing elements 72 and the return conductor 91. An optimum response can be determined with models, empirically, or with some combination of the two.

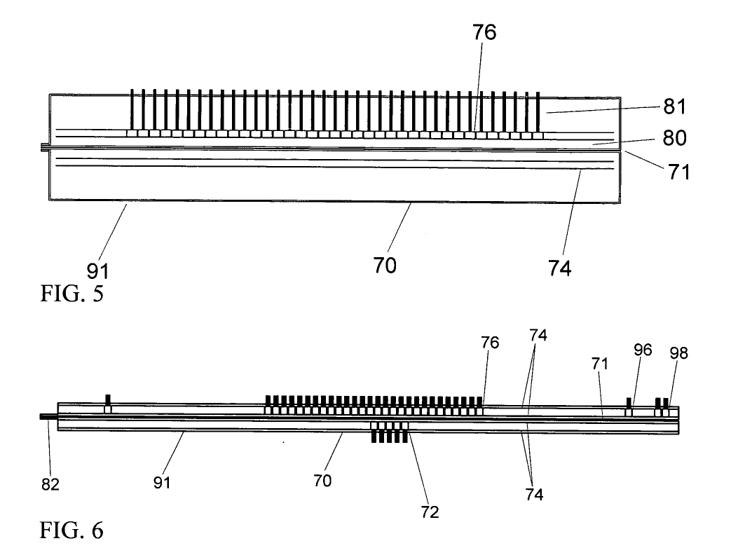

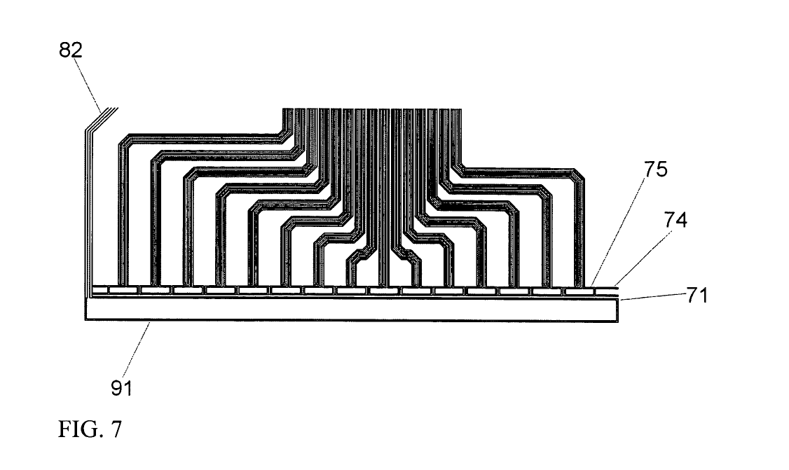

An example of a modified sensor design is shown FIG. 5. In this sensor array, all of the sensing elements 76 are on one side of the central drive windings 71. The size of the sensing elements and the gap distance 80 to the central drive windings 71 are the same as in the sensor array of FIG. 4. However, the distance 81 to the return of the drive winding has been increased, as has the drive winding width to accommodate the additional elements in the single row of elements. Increasing the distance to the return reduces the size of the response when the return crosses a feature of interest such as a crack. Another example of a modified design is shown in FIG. 6. Here, most of the sensing elements 76 are located in a single row to provide the basic image of the material properties. A small number of sensing elements 72 are offset from this row to create a higher image resolution in a specific location. Other sensing elements are distant from the main grouping of sensing elements at the center of the drive windings to measure relatively distant material properties, such as the base material properties for plates at a lap joint or a weld.

In an embodiment of the invention, the number of conductors used in the primary winding can be reduced further so that a single rectangular drive is used. As shown in FIG. 7, a single loop having extended portions is used for the primary winding. A row of sensing elements 75 is placed on the outside of one of the extended portions. This is similar to designs described in U.S. Pat. No. 5,453,689 where the effective wavelength of the dominant spatial field mode is related to the spacing between the drive winding and sensing elements. This spacing can be varied to change the depth of sensitivity to properties and defects. In one embodiment of the invention, this distance is optimized using models to maximize sensitivity to a feature of interest such as a buried crack or stress at a specific depth. Advantages of the design in FIG. 7 include a narrow drive and sense structure that allows measurements close to material edges and non-crossing conductor pathways so that a single layer design can be used with all of the conductors in the sensing region in the same plane. The width of the conductor 91 farthest from the sensing elements can be made wider in order to reduce an ohmic heating from large currents being driven through the drive winding. Sense elements can be placed on the opposite side of the drive 71 at the same or different distances from the drive. Sensing elements can be placed in different layers to provide multiple lift-offs at the same or different positions.

The MWM sensor and sensor array structure can be produced using micro-fabrication techniques typically employed in integrated circuit and flexible circuit manufacture. This results in highly reliable and highly repeatable (i.e., essentially identical) sensors, which has inherent advantages over the coils used in conventional eddy-current sensors. The sensor was also designed to produce a spatially periodic magnetic field in the MUT so that the sensor response can be accurately modeled which dramatically reduces calibration requirements. For example, calibration in air can be used to measure an absolute electrical conductivity without calibration standards, which makes the sensor geometry well-suited to surface mounted or embedded applications where calibration requirements will be necessarily relaxed.

For applications at temperatures up to 120° C. (250° F.), the windings are typically mounted on a thin and flexible substrate, producing a conformable sensor. A higher temperature version has shown a good performance up to about 270° C. (520° F.). In another embodiment of the invention, these sensors might be fabricated on ceramic substrates or with platinum leads and Boron Nitride coatings or other means to extend their operating temperature range. The sensors, which are produced by microfabrication techniques, are essentially identical resulting in highly reliable and highly repeatable performance with inherent advantages over the coils used in conventional eddy-current sensors providing both high spatial reproducibility and resolution. For conformable sensors, the insulating layers can be a flexible material such as Kapton™, a polyimide available from E. I. DuPont de Nemours Company, while for high temperature applications the insulating layers can be a ceramic such as alumina.

For measuring the response of the individual sensing elements in an array, multiplexing between the elements can be performed. However, this can significantly reduce the data acquisition rate so a more preferably approach is to use an impedance measurement architecture that effectively allows the acquisition of data from all of the sense elements in parallel. Furthermore, ability to measure the MUT properties at multiple frequencies extends the capability of the inspection to better characterize the material and/or geometric properties under investigation. This type of instrument is described in detail in U.S. patent application Ser. No. 10/155,887, filed May 23, 2002, the entire teachings of which are incorporated herein by reference. The use of multiple sensing elements with one meandering drive and parallel architecture measurement instrumentation then permits high image resolution in real-time and sensitivity with relatively deep penetration of fields into MUT.

An efficient method for converting the response of the MWM sensor into material or geometric properties is to use grid measurement methods. These methods map the magnitude and phase of the sensor impedance into the properties to be determined and provide for a real-time measurement capability. The measurement grids are two-dimensional databases that can be visualized as “grids” that relate two measured parameters to two unknowns, such as the magnetic permeability (or electrical conductivity) and lift-off (where lift-off is defined as the proximity of the MUT to the plane of the MWM windings). For the characterization of coatings or surface layer properties, three- (or more)-dimensional versions of the measurement grids called lattices and hypercubes, respectively, can be used. Alternatively, the surface layer parameters can be determined from numerical algorithms that minimize the least-squares error between the measurements and the predicted responses from the sensor, or by intelligent interpolation search methods within the grids, lattices or hypercubes.

An advantage of the measurement grid method is that it allows for real-time measurements of the absolute electrical properties of the material and geometric parameters of interest. The database of the sensor responses can be generated prior to the data acquisition on the part itself, so that only table lookup and interpolation operations, which are relatively fast, needs to be performed. Furthermore, grids can be generated for the individual elements in an array so that each individual element can be lift-off compensated to provide absolute property measurements, such as the electrical conductivity. This again reduces the need for extensive calibration standards. In contrast, conventional eddy-current methods that use empirical correlation tables that relate the amplitude and phase of a lift-off compensated signal to parameters or properties of interest, such as crack size or hardness, require extensive calibrations using standards and instrument preparation. The database could also include other properties or parameters of interest, such as the damage conditions or even the progression of these damage condition, for rapid assessment and decision support purposes.

For ferromagnetic materials, such as most steels, a measurement grid provides conversion of raw data to magnetic permeability and lift-off. A representative measurement grid for ferromagnetic materials (e.g., carbon and alloy steels) is illustrated in FIG. 6. A representative measurement grid for a low-conductivity nonmagnetic alloy (e.g., titanium alloys, some superalloys, and austenitic stainless steels) is illustrated in FIG. 7. For coated materials, such as cadmium and cadmium alloys on steels, the properties of the coatings can be incorporated into the model response for the sensor so that the measurement grid accurately reflects, for example, the permeability variations of substrate material with stress and the lift-off. Lattices and hypercubes can be used to include variations in coating properties (thickness, conductivity, permeability), over the imaging region of interest.

Methods such as MWM-Array sensing can provide observability of precrack damage and imaging of clusters of small fatigue cracks with sufficient warning to perform mitigating rework/repair actions, e.g., blending and shot peening. Such rework/repair options are generally limited to relatively shallow cracks, e.g., less than 0.25 mm (0.01 in.) deep in a fatigue critical component or other damage, e.g., pits. Thus, early detection is the key.

Furthermore, precursor states can also be monitored to reduce the probability of failure by removing components from service or reworking components that are more susceptible to failures. For example, the MWM is used to qualify the cold working of aluminum propeller blades. For these blades, a ratio of two conductivity measurements is used to ensure that the residual stresses are sufficiently compressive to prevent crack initiation. Blades are inspected to determine whether they need to be reworked (rerolled) before they are returned to the fleet. This is a direct use of CBM for life extension and failure prevention. In this example, observability of one precursor state, e.g., residual stresses, in itself is sufficient. In other examples, a balance must be provided between emphasis on depot, field and onboard observability to support prevention of different failure modes. One such activity is condition assessment for precursor states to remove components susceptible to failure from populations of critical parts. Another is NDE in the depot and field to detect damage early enough so that rework and repair actions can be utilized to extend life. For later stage damage, NDE can determine the need to remove components or introduce repairs if damage has progressed to a level that will not statistically or deterministically ensure damage tolerance and durability beyond the next inspection. Another activity is the use of onboard diagnostics and new onboard NDE methods for PHM to prevent impending failures, as well as to detect damage early enough to reduce repair/replacement costs. Similarly, fleetwide and individual component tracking for critical components can provide strategic planning opportunities and focus on overall costs and sustainment issues. While the focus of this description has been on flight critical components of aircraft, including engines, landing gear, and other structures, the method but is sufficiently general to apply to critical components in other military and commercial platforms.

Widespread fatigue damage (WFD) is an example of fatigue damage that helps describe observability requirements associated with ADT. WFD has become a major concern for both fighter and commercial aircraft. It has been defined as the occurrence of multiple cracks or clusters of small cracks sufficient to reduce a component's residual strength to a level at which the component is no longer damage tolerant. WFD includes both multi-site damage and multi-element damage. For example, on the Boeing 727/737 fleet, WFD in the lap joint manifests itself as multiple site cracking in the third skin layer. This cracking initiates as shallow cracks from bending fatigue. These cracks are tight and do not extend through the thickness of the third skin layer until they reach about 2.5 mm (0.1-in.) in length, making them far more difficult to detect than through cracks. Also, they most often occur at multiple sites within the lap joint. Models for such WFD phenomenon are taking on new importance, but the need for new sensor technologies for early detection and quantitative characterization is also critical. MWM-Arrays have been used to detect and characterize this damage and have also been used to create images of property variations in aluminum bending fatigue specimens where clusters of microcracks have formed in the vicinity of large visible cracks [Goldfine, 2003]. Clearly, the crack growth rate for an isolated discrete crack will be different compared to crack growth in areas with multiple small cracks. This phenomenon is of great concern not only for lap joints, but also for other critical components (e.g., bending fatigue in regions with fretting damage of engine disk slots).

These clusters of cracks often occur at complex geometries, such as such as in bending fatigue regions on F-18 bulkheads and in the fillet region of the F-15 wing pylon rib. For the F-15 wing pylon rib example, clusters of small corrosion fatigue cracks form, some at obvious corrosion pits and others apparently away from pits. These cracks then appear to coalesce into long but shallow cracks with depth significantly less than 0.25 mm (0.01 in) deep. For this F-15 component, the critical crack size is on the order of 0.25 mm (0.01 in.) in terms of depth as reported based on metallurgical evaluations of failed components.

Unfortunately, this seems to be below the detection threshold of conventional ultrasound and eddy current techniques used on this part, since until recently no cracks had been detected on this F-15 component before failure, even though several failures have occurred in service. In a recent demonstration, the MWM-Array detected several small crack indications, on a service exposed F-15 wing pylon rib, that were later confirmed using acetate replicas. This demonstrates the MWM-Array capability to observe (detect) early damage conditions, prior to other NDE methods. The F-15 wing pylon rib example is particularly noteworthy because the failure mode often results from an upset event that is apparently of concern only if these shallow cracks are present. Without this upset event, the propagation of damage is slow and apparently tolerable.

There has been substantial pressure on NDE technologies to provide lower and lower detection thresholds for discrete cracks so that DT-based NDE inspection intervals can be increased—reducing total ownership costs and reducing the logistics burden on airlines and military aircraft operators. Examples are the goal to provide reliable detection of 0.5 mm by 0.5 mm (0.02 in. by 0.02 in.) cracks under fastener heads in lap joints or 0.25 mm (0.01 in.) by 0.13 mm (0.005 in.) cracks in Ti-6Al-4V engine disk slots. For many applications, the return on investment from damage tolerance and related retirement for cause methods has been substantial, such as the RFC facilities. The tradeoff for improved NDE detection sensitivity is generally the capability to tolerate false indications. For this reason, damage tolerance and other health monitoring implementations should include rework/repair options and methods for verifying indications, e.g., acetate replicas.

For many applications, the progression of damage occurs well below the current detection capability for discrete cracks for much of the component life. In these cases the “window of opportunity” for conventional NDE is very short or even non-existent. For example, the capability to detect precrack fatigue damage prior to formation of any detectable cracks has been demonstrated for some materials.

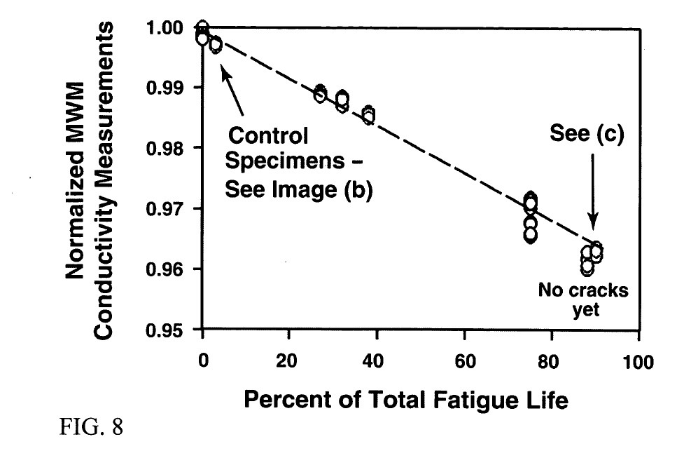

FIG. 8 shows the progression of fatigue damage on type 304 stainless steel during life produces a nearly linear reduction in this effective property. Note this “effective conductivity change” is physically attributed to a permeability change. Each data point represents a different specimen. Each specimen was tested to a fraction of total life. The total life was determined as a mean number of cycles to failure in a separate set of specimens from the same lot of material. Both sets of specimens were tested under the same test conditions. Images of the magnetic permeability of the specimens clearly illustrates that the fully annealed material has a relative magnetic permeability of 1.0 when not cyclically loaded, and the permeability is significantly greater than 1.0 as fatigue develops.

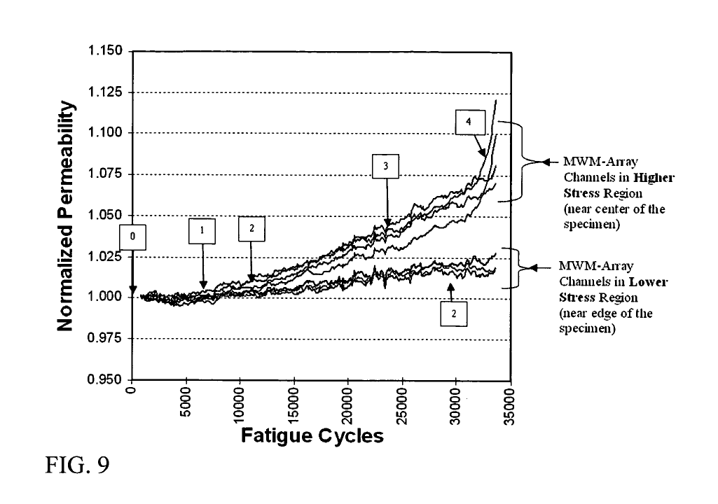

FIG. 9 shows the results of a fatigue test on a shot peened 4340 steel specimen with a geometric feature prototypical of that encountered in a critical landing gear steel component. Here, a surface mounted MWM-Array was used to monitor the progression of fatigue damage from the as manufactured condition to crack initiation. The specimen was designed to provide a high stress region in the center of the part, as confirmed by the finite element analysis.

The test was stopped when the MWM-Array indicated that the permeability change began to accelerate. After the test, the gage section of the fatigue specimen was examined in a scanning electron microscope (SEM). The largest crack detected by the SEM examination of the surface is approximately 200 micron (0.008 in.), although a subsequent destructive analysis indicated significant subsurface damage as well. The part was also scanned with a higher resolution MWM-Array. This illustrates the capability of both surface mounted and scanning MWM-Arrays to observe the progression of “precrack” damage and potentially to estimate the rate of progression of this damage. Clearly, detection of such small cracks, <0.25 mm (<0.01 in.) in length, is unlikely with other common nondestructive methods. Cracks of this type propagate to failure quickly from this stage on. Thus, to implement ADT for landing gear, precrack damage monitoring is essential.

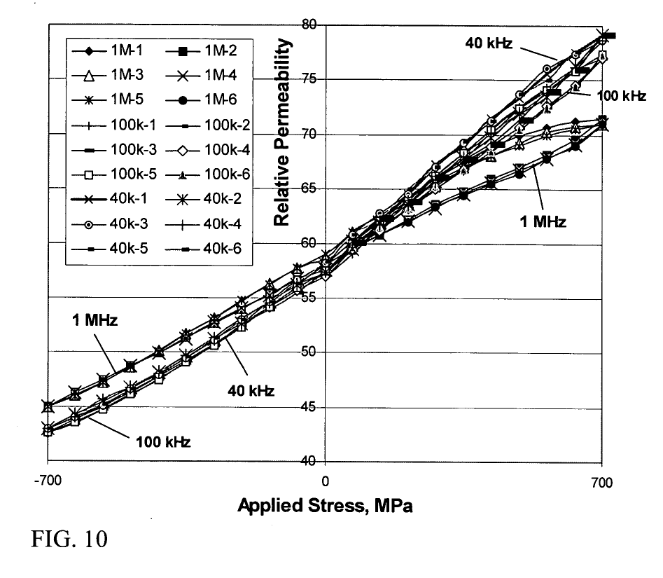

Early stage fatigue crack detection has been demonstrated with MWM-Arrays permanently mounted against the surface of a material. As described in U.S. patent application Ser. Nos. 09/666,879 and 09/666,524, crack initiation and growth rates have been monitored in aluminum alloys with linear arrays inside holes, with circular arrays around fasteners, and with circular arrays mounted between layers around fasteners. These sensors have also demonstrated the capability to monitor stress variations in steels as described in U.S. patent application Ser. No. 10/441,976, filed May 20, 2003, the entire teachings of which are incorporated herein by reference. FIG. 10 shows MWM permeability measurements on 300M high-strength steel specimens under fully reversed bending loading. MWM magnetic permeability measurements were performed with the longer segments of the MWM drive winding perpendicular to the bending stress direction. In this orientation, the MWM measures permeability in the specimen longitudinal direction. FIG. 10 shows how the permeability measured at frequencies of 40 kHz, 100 kHz, and 1 MHz changes with applied bending stress. The data illustrate the sensitivity and quality of the permeability measurements for stress measurements in high strength steels over a wide range of stresses. The results clearly show the sensitivity of the MWM measurements to stress changes and reasonably small hysteresis, particularly in the compressive stress range. This same approach can be applied to the detection of overloading which results in plastic deformation and residual stress redistribution. For low excitation frequencies required for deep magnetic field penetration into the test material or for sensing deep property changes through material layers, alternative sensing elements such as magnetoresistive or giant magnetoresistive sensors, as described for example in U.S. patent application Ser. No. 10/045,650, filed Nov. 8, 2001, the entire teachings of which are incorporated herein by reference, permits measurements to a significantly greater depth.

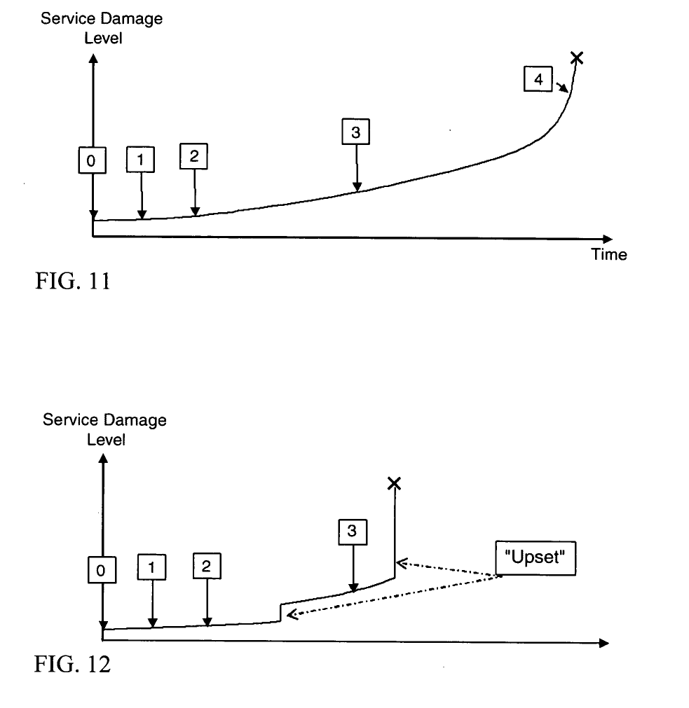

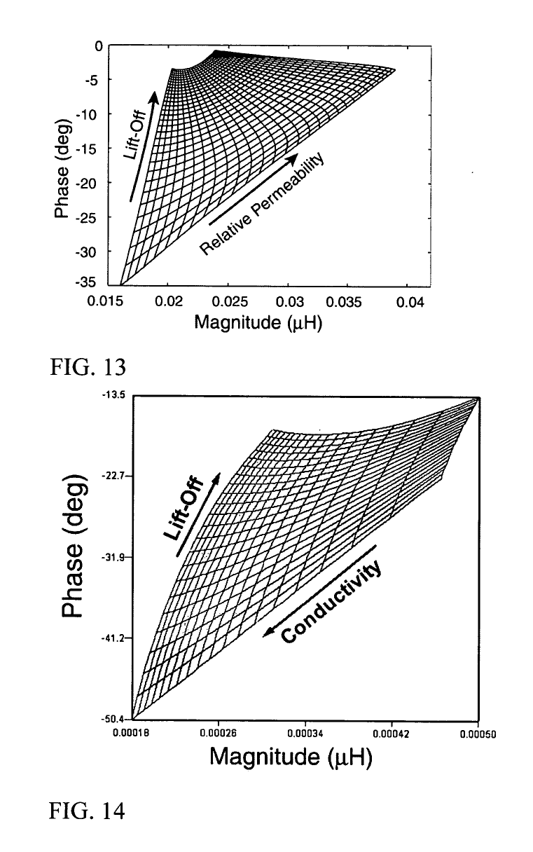

ADT implementation also requires an understanding of damage progression behavior. For the purposes of illustrating the ADT framework and its value, this next example defines damage progression in terms of four behavior stages (illustrated in FIG. 9 and FIGS. 11 and 12): (1) Damage Initiation, (2) Early Stage Damage Progression, (3) Intermediate Stage Damage Progression, and (4) Late Stage/Accelerated Damage Progression. Damage initiation occurs in the first stage. In some components, detectable damage accumulates from the beginning of exposure to service loads and can be monitored over time. In other components, damage that could eventually result in a failure would not accumulate at any significant rate and avoids detection until a specific “upset” event occurs that may enhance the primary damage mode so that failure occurs after a rather short period of time. A more common scenario, as illustrated in FIG. 11, includes the damage initiation stage (1). Also, precursor conditions or states that enhance or inhibit damage initiation and progression have substantial influence during this damage initiation stage. Thus, the initial manufacturing/rework condition has a substantial influence during this stage. During the second stage, damage progresses slowly. During this stage, when detected, rework/repair actions can typically recover (recapitalize) much of the component's remaining life. Also, during this stage there is a low likelihood of failure, even if a severe damage accelerating event (upset event) occurs, e.g., overload or over-temperature. During the third, the damage progression has accelerated somewhat, but does not reach levels at which corrective actions cannot be taken or failure is imminent. However, in this stage a damage accelerating event (upset event) may move the component to a state where failure becomes imminent or immediate catastrophic failure occurs. At some point, denoted by the fourth stage, the damage accumulation begins to accelerate so that failure is imminent and the likelihood of having an inspection before failure is too low due to the short window of opportunity. In FIGS. 11 and 12, Stages 2-4 represent different stages of damage evolution, while the damage initiation stage 1 is influenced by the initial manufacturing/rework condition referred to as the damage precursor state (0).

For the 4340 steel fatigue test, as seen in FIG. 9, the first stage (up to 7000 cycles) with the initially flat response of the magnetic permeability represents behavior prior to detectable damage. Early Stage Damage Progression begins at around 7000 cycles and extends to, perhaps, 17,000 cycles for the center channels in the higher stress region. The outside channels of the sensor, in the lower stress regions near the edges of the component, remain in this Early Damage Stage throughout the test. The center channels transition to Intermediate Stage Damage Progression at about 17,000 cycles. The transition from Intermediate to Late Stage/Accelerated Damage Progression occurs between 30,000 and 33,000 cycles for two of the center channels, while the other two center channels show continued but slower accumulation of damage.

As an example, consider the application of ADT to the problem of landing gear fatigue monitoring. The first step is to develop and validate an empirically based or physics based model of the damage mode progression. This includes determination of the damage precursor, damage and usage states that must be monitored for the failure mode of interest. Damage precursor states might include, for example, representations of residual stress distributions, microstructure characteristics or surface finish. Damage states might include changes in the dislocation structure, the density and distribution of microcracks, the relative proximity of adjacent cracks or maximum crack size. Usage states might include cycle counting and/or vibration and strain measurements. Unfortunately, models of microcrack formation and coalescence are not yet fully developed, especially for situations with complex stress and material profiles, such as shot peened and coated systems. Thus, it is likely that an empirically derived and validated model will be required in the near term while such models evolve.

For the landing gear monitoring example, during Stages 1 and 2, the inspections might include only data analysis from permanently mounted sensors such as MWM-Arrays after each landing. These would not require any disassembly. Cables from each of several MWM-Arrays could be accessed from an easy access location and the data off-loaded for automatic analysis. Also, during Stages 1 and 2, upset event detection should be included to launch unscheduled inspections for critical locations. For example, scanning high resolution MWM-Arrays can produce images of areas of interest, in addition to the monitoring of permanently mounted sensors. During Stage 3 or after any hard landing, scanning MWM-Arrays might be used in locations identified by the ADT as requiring shorter inspection intervals with higher sensitivity to specific damage states. This might require partial disassembly. Finally, in Stage 3, nearly continuous monitoring, during and after each take-off and landing, might be required to prevent catastrophic failures. It is assumed that inspection during Stage 4, while not unreasonable, may be too late to prevent failures.

Also, at any stage in the process, recapitalization actions might be taken. An example action is the stripping of coatings and re-shot peening after careful inspections, possibly with MWM-Arrays, for cracks or “precrack” damage and an assessment of the residual stresses. Borescope examinations and/or acetate replicas of suspect areas can also be used for verification. After recapitalization the precursor, damage, and usage states must be reset in some way to continue with the ADT methodology.

Observable early stage progression has been observed in a variety of systems. One example is the corrosion fatigue in the aluminum F-15 wing pylon rib. Another is the thermal aging of a thermal spray coating on a turbine blade [Goldfine, October 2002]. A third is cold work or cold rolling of P-3/C-130 propellers, for which a manufacturing or rework condition can prevent the progression of fatigue damage. The enabling component of ADT is improved observability of early damage progression states and the rates of change of these states. Four examples are given in Table 1 to illustrate variations in these observability requirements.

Each of the examples described in the following experience several stages of damage evolution. The terminology in this paper was chosen to represent a generic damage evolution process (no attempt is made to provide universally self-consistent materials degradation terminology). The goal is to provide a framework for building an ADT methodology.

TABLE 1
Damage observability requirements for three example applications
Damage

| | | | | Late Stage/ |
|---|---|---|---|---|
| State | Damage Precursor & or | | Intermediate Stage | Accelerated |
| Application | Damage Initiation | Early Stage Damage | Damage | Damage |
| Landing Gear | Detection of stress | Detection, monitoring | Detection of multiple | Real-time |
| Fatigue | relaxation or upset events | and characterization of | microcracks & | detection of near- |
| | that produce regions with | precrack fatigue | assessment of residual | critical cracks and |
| | reduced compressive stress | damage | strength loss | removal of |
| | or with tensile stresses | | | component from |
| | | | | service |
| F-15 Wing Pylon | Detection of corrosion pits. | Detection of multiple | Detection of multiple | Detection of |
| Rib Corrosion- | May repair shallow pits | small cracks including | cracks, 75 to 250 μm | cracks that are |
| Fatigue | (e.g., blend and shot peen) | those emanating from | (0.003 to 0.010 in.) | >0.25 mm (0.01 |
| | | pits, e.g., cracks <75 | deep & removal of | in) deep may be |
| | | μm (0.003 in.) deep | component from | too late for failure |
| | | | service | prevention |
| Turbine Blade | Detection of manufactured | Early stage depletion | Aluminum levels too | Inspect for cracks |
| Coating Thermal | conditions that may result | of aluminum (action: | low to support damage | and material |
| Aging | in accelerated thermal | monitor, do not need | tolerance (action: strip | degradation from |
| | degradation. | to replace) | and replace coating, | later stage |
| | | | inspect substrate) | damage (action: |
| | | | | remove from |
| | | | | service). |
| C-130/P-3 | Detection of improper roller | Detection of stress | On-board diagnostics | Too late for |
| Propeller | burnishing condition | relaxation, or removal | may be an option | failure |
| Fatigue Damage | (corrective action: reroll | of excessive material | | prevention? |
| | blade) | during corrosion | | |
| | | mitigation (corrective | | |
| | | action: reroll blade or | | |
| | | remove from service). | | |

As illustrated in FIGS. 9, 11, and 12, some damage modes progress slowly and then, for example, upon coalescence of multiple small cracks or upon an upset event, damage propagation accelerates rapidly. If early stages of damage can be detected (e.g., for landing gear components, or for the corrosion fatigue in the F-15 wing pylon rib), then fleet wide component replacements can either be prevented, delayed or staged. Such fleet wide replacements may take between one and ten years for a large fleet. During this time, the order in which components have typically been replaced is often based on a combination of usage and access/readiness issues. Also, a severe inspection regimen is often added to the field maintenance burden. If ADT, including observability within the early and intermediate damage progression stages, is implemented, then a more practical and economical alternative can be provided adding knowledge of the damage states and their progression to the mix of available information to support such fleet-wide decisions.

Critical issues for robust inspections with surface mounted sensors are recalibration and on-board diagnostics. Recalibration can involve taking measurements at multiple temperatures and using well-established relationships for the conductivity variation with temperature. For example, by using property value measurements for at least two different temperatures for each sense element, offsets and scales factors can be determined which adjust the property measurements. These correction factors can be applied to the raw impedance data or to the effective estimated properties.

Similar methods are available for sensor diagnostics. Such diagnostic methods can be used to avoid false positive indications and reliability lapses caused by sensor malfunctions and data misinterpretations. Two such methods are (1) to monitor the lift-off (sensing element proximity to the surface) at each sensing element to verify that the sensor has not moved as well as to provide a verification of sensor operational performance and (2) by measuring at two different temperatures the change in conductivity for each sense element. For example, it is unlikely that the sensing element lift-off measurement will remain within 2.54 micron (0.0001-in.) of its expected value if the sensing element is not properly functioning.

While this invention has been particularly shown and described with reference to preferred embodiments thereof, it will be understood by those skilled in the art that various changes in form and details may be made therein without departing from the scope of the invention encompassed by the appended claims.

References incorporated by reference in their entirety:

Goldfine, N., Zilberstein, V., Washabaugh, A., “Material Condition Monitoring Using Embedded and Scanning Sensors for Prognostics,” presentation at the 57^{th} MFPT Conference, Virginia Beach, Va. 2003.

Goldfine, N., Zilberstein, V., Cargill, S., Schlicker, D., Shay, I., Washabaugh, A., Tsukernik, V., Grundy, D., Windoloski, M., “MWM-Array Eddy Current Sensors for Detection of Cracks in Regions with Fretting Damage,” Materials Evaluation, ASNT, Vol. 60, No. 7, pp 870-877; July 2002.

Washabaugh, A., Zilberstein, V., Lyons, R., Walrath, K., Goldfine, N., Abramovici, E., “Fatigue and Stress Monitoring Using Scanning and Permanently Mounted MWM-Arrays,” 29th Annual Review of Progress in QNDE; Bellingham, Wash.; July 2002.

Goldfine, N., Schlicker, D., Sheiretov, Y., Washabaugh, A., Zilbertein, V., Lovett, T. “Conformable Eddy-Current Sensors and Arrays for Fleetwide Gas Turbine Component Quality Assessment,” published in ASME Journal of Engineering for Gas Turbines and Power, Vol. 124, No. 4, pp. 904-909, October 2002.

Kaplan, M. P. and Wolff, T. A., “Life Extension and Damage Tolerance of Aircraft,” in Fatigue and Fracture, ASM Metals Handbook, Tenth Edition, pp. 557-565, 1996.

Swift, T., “Damage Tolerance Certification of Commercial Aircraft,” ASM Handbook, 10^{th} Edition, 1996.

The following references are also incorporated herein by reference in their entirety.

1. DOE Phase II Proposal, titled “Intelligent Probes for Enhanced Non-Destructive Determination of Degradation in Hot-Gas-Path Components,” Topic #44c, dated Mar. 23, 2002.

2. Air Force Phase II Proposal, titled “Detection and Imaging of Damage, Including Hydrogen Embrittlement Effects in Landing Gear and Other High-Strength Steel Components,” Topic #AF01-308, dated Apr. 9, 2002.

3. NASA Phase II Proposal, titled “Shaped Field Giant Magnetoresisitive Sensor Arraysfor Materials Testing,” Topic #01-II A1.05-8767, dated May 2, 2002

4. Navy Phase I Proposal, titled “Observability Enhancement and Uncertainty Mitigation for Engine Rotating Component PHM,” Topic #N02-188, dated Aug. 14, 2002.

5. Final Report submitted to NASA, titled “Shaped Field Giant Magnetoresisitive Sensor Arrays for Materials Testing,” dated May 3, 2002.

6. Final Report submitted to Air Force, titled “Detection and Imaging of Damage, Including Hydrogen Embrittlement Effects in Landing Gear and Other High-Strength Steel Components,” dated Jul. 3, 2002.

7. Technical Report titled “MWM Examination of Twenty X2M Steel Fatigue Specimens After Abusive Grinding,” US ARMY Final Report 08162002.

8. Technical paper titled “Friction Stir Weld Inspection through Conductivity Imaging using Shaped Field MWM®-Arrays,” Proceedings of the 6^{th} International Conference on Trends in Welding, Callaway Gardens, Ga.; ASM International, January 2003.

9. Technical paper titled “MWM Eddy Current Sensor Array Imaging of Surface and Hidden Corrosion for Improved Fleet Readiness and Cost Avoidance,” presented at U.S. Army Corrosion Conference, Clearwater Beach; FL, Feb. 11-13, 2003.

10. Technical paper titled “MWM Eddy Current Sensor Array Characterization of Aging Structures Including Hidden Damage Imaging,” presented to the to Aerospace Committee, NACE Conference, San Diego; CA, Mar. 17-19, 2003.

11. Technical paper titled “Remote Temperature and Stress Monitoring Using Low Frequency Inductive Sensing,” presented at the SPIE NDE/Health Monitoring of Aerospace Materials and Composites, San Diego, Calif., Mar. 2-6, 2003

12. Technical paper titled “In-Situ Crack Detection and Depth Discrimination for Coated Turbine Blade Contact Faces,” presented at the ASNT Spring Conference, Orlando, Fla., Mar. 10-14, 2003.

13. Technical paper titled “Nondestructive Evaluation for CBM and PHM of Legacy and New Platforms,” presented at 57^{th} MFPT Conference, Virginia Beach, Va.; April 2003.

14. Technical paper titled “Eddy Current Sensor Networks for Aircraft Fatigue Monitoring,” Materials Evaluation, July 2003, Volume 61, No. 7

What is claimed is:

1. A method for monitoring condition of a material, said method comprising:
representing the condition of the material with multiple states, at least one of the states observable with an inspection;
using the multiple states with a model to estimate state progression; and
scheduling an inspection based on the progression of the multiple states.

2. A method as claimed in claim 1 wherein the states comprise a damage state.

3. A method as claimed in claim 1 wherein the states comprise a precursor state.

4. A method as claimed in claim 1 wherein the model is used to pre-compute a database of damage progression conditions as a function of the states for rapid assessment of damage condition for decision support.

5. A method as claimed in claim 1 wherein the states are selected to ensure observability of a particular damage progression behavior mode.

6. A method as claimed in claim 1 wherein at least one of the multiple states is an initially preassumed crack size.

7. A method as claimed in claim 1 wherein the inspection is performed by a nondestructive evaluation method.

8. A method as claimed in claim 1 wherein the inspection comprises onboard diagnostics.

9. A method as claimed in claim 1 wherein the inspection comprises eddy current sensors mounted on a surface of the material.

10. A method as claimed in claim 1 wherein at least one of the states is fatigue.

11. A method as claimed in claim 10 wherein fatigue damage progression is monitored continuously.

12. A method as claimed in claim 10 wherein fatigue damage progression is monitored occasionally.

13. A method as claimed in claim 12 further comprising:
increasing frequency of inspection for fatigue damage progression monitoring as the damage progresses.

14. A method as claimed in claim 1 wherein the model is adapted as the states progress.

15. A method as claimed in claim 1 wherein the material is part of an aircraft component.

16. A method as claimed in claim 15 further comprising:
deciding disposition of a component based on the material condition states.

17. A method as claimed in claim 16 wherein the disposition comprises aircraft maintenance.

18. A method as claimed in claim 16 wherein the disposition comprises repair or rework.

19. A method as claimed in claim 16 wherein the disposition comprises airworthiness.

20. A method as claimed in claim 1 further comprising:
monitoring rates of change of states.

21. A method as claimed in claim 21 wherein the rates of change of selected states are determined from inspections at at least two different times.

22. A method as claimed in claim 1 further comprising:
selecting a health control action designed to achieve a quantitative goal according to a control algorithm.

23. A method as claimed in claim 22 wherein the control action is rework.

24. A method as claimed in claim 23 wherein the rework is shot peening.

25. A method as claimed in claim 22 wherein the quantitative goal is a reduction of total ownership cost without reducing readiness.

26. A method as claimed in claim 25 wherein the quantitative goal is constructed from an assessment of available quantitative current and historical information combined with expert qualitative information.

27. A method for health control of an article comprising:
examining material condition of an article with an eddy current sensor;
determining presence of an early stage damage;
performing a health control action on the article; and
establishing a baseline condition for future inspections with another examination of the article with the eddy current sensor.

28. A method as claimed in claim 27 wherein the eddy current sensor is a sensor array.

29. A method as claimed in claim 27 wherein the sensor is mounted to a surface of the article.

30. A method as claimed in claim 27 wherein the sensor is scanned over a surface of the article.

31. A method as claimed in claim 27 further comprising:
integrating the health control action with scheduling of inspections.

32. A method as claimed in claim 27 wherein the control action is rework.

33. A method as claimed in claim 32 wherein the rework is shot peening.
